(19) United States
(12) Patent Application Publication
(10) Pub. No.: US 2026/0022216 A1
(43) Pub. Date: Jan. 22, 2026

(54) ELECTRICALLY CONDUCTIVE RUBBER MATTING

(71) Applicant: Justrite Manufacturing Company, LLC, Deerfield, IL (US)

(72) Inventor: James Tarvin, Deerfield, IL (US)

(21) Appl. No.: 19/273,501

(22) Filed: Jul. 18, 2025

Related U.S. Application Data
(60) Provisional application No. 63/673,049, filed on Jul. 18, 2024.

(51) Int. Cl. C08J 3/20; B32B 25/08; B32B 27/30; C08K 3/04; C08K 3/10

(52) U.S. Cl. CPC C08J 3/203; B32B 25/08; B32B 27/304; C08K 3/041; C08K 3/10; B32B 2250/02; B32B 2250/24; B32B 2264/108; B32B 2264/302; B32B 2270/00; B32B 2307/202; B32B 2319/00; B32B 2327/06; B32B 2375/00; B32B 2471/04; C08J 2309/02; C08J 2427/06

(57) ABSTRACT

Examples provide a method for manufacturing electrically conductive rubber matting. The method includes charging, into an internal mixer, a set of ingredients for forming a rubber compound. The set of ingredients include 63.2 weight percent (wt %) to 73.2 wt % nitrile rubber, 25.0 wt % to 35.0 wt % polyvinyl chloride (PVC) plastic, 0.02 wt % to 1.0 wt % PVC stabilizer, and 0.8 wt % to 2.6 wt % carbon nanostructures not including carbon black. The ingredients are mixed at a first speed at least until a measured temperature in the internal mixer reaches a first threshold temperature. The ingredients are mixed at a second speed that is greater than the first speed at least until the measured temperature in the internal mixer reaches a second threshold temperature that is greater than the first threshold temperature. After mixing, the rubber compound is discharged the rubber compound from the internal mixer and shaped.

### RELATED APPLICATIONS

This application claims the benefit of U.S. Provisional Patent Application No. 63/673,049, filed Jul. 18, 2024, the entire content of which is hereby incorporated by reference.

### FIELD

Embodiments herein relate to rubber matting.

### SUMMARY

Electrically conductive rubber mats, otherwise referred to as anti-static rubber mats or anti-fatigue rubber mats, are used in many industries and work environments such as manufacturing facilities, hospitals, laboratories, cleanrooms, hazardous environments (e.g., areas with explosive chemicals), server rooms, and the like. These mats protect sensitive equipment from static electricity and particulate matter attracted to static electricity by quickly drawing the static electricity off individuals before those individuals touch the equipment.

Conductive rubber mats are conventionally made using carbon black as the conductive additive in the rubber compound. However, the use of carbon black in conductive rubber mats limits the coloring of the conductive rubber mats to black. Additionally, the carbon black additives included in conductive rubber mats often leave a black residue on equipment and workers that contact the rubber mats. For example, the carbon black pigment of rubber mats may leave markings on the shoes of workers, which may thereby spread the pigment to the floors or other surfaces of a clean environment, such as a hospital, laboratory, cleanroom, or the like.

Thus, there is a need for non-marking electrically conductive rubber matting. One example provides a method for manufacturing electrically conductive rubber matting. The method includes charging, into an internal mixer, a set of ingredients for forming a rubber compound, the set of ingredients comprising 63.2 weight percent (wt %) to 73.2 wt % nitrile rubber, 25.0 wt % to 35.0 wt % polyvinyl chloride (PVC) plastic, 0.02 wt % to 1.0 wt % PVC stabilizer, and 0.8 wt % to 2.6 wt % carbon nanostructures; lowering a ram of the internal mixer; mixing, with the internal mixer, the set of ingredients at a first speed; in response to a measured temperature in the internal mixer reaching a first threshold temperature, mixing the set of ingredients at a second speed that is greater than the first speed; in response to the measured temperature in the internal mixer reaching a second threshold temperature that is greater than the first threshold temperature, discharging the rubber compound from the internal mixer; and shaping the rubber compound, wherein the carbon nanostructures do not include carbon black.

In some aspects, the carbon nanostructures include carbon nanotubes.

In some aspects, the rubber compound is a color other than black.

In some aspects, the rubber compound is a non-marking rubber matting.

In some aspects, the rubber compound has a volume resistivity of 10⁶ Ohms per centimeter (Ω-cm).

In some aspects, the set of ingredients includes 100% natural rubber.

In some aspects, the set of ingredients includes 67.2 wt % to 69.2 wt % nitrile rubber.

In some aspects, the set of ingredients includes 29.0 wt % to 31.0 wt % PVC plastic.

In some aspects, the set of ingredients includes 0.04 to 0.08 wt % PVC stabilizer.

In some aspects, the set of ingredients includes 1.20 wt % to 2.20 wt % carbon nanostructures.

In some aspects, the first speed is between 30 rotations per minute (RPM) and 40 RPM.

In some aspects, the first speed is 35 RPM.

In some aspects, the second speed is between 40 RPM and 50 RPM.

In some aspects, the second speed is 45 RPM.

In some aspects, the first threshold temperature is between 200 degrees Fahrenheit and 250 degrees Fahrenheit.

In some aspects, the first threshold temperature is 225 degrees Fahrenheit.

In some aspects, the second threshold temperature is between 285 degrees Fahrenheit and 335 degrees Fahrenheit.

In some aspects, the second threshold temperature is 310 degrees Fahrenheit.

In some aspects, the method further includes responsive to the measured temperature in the internal mixer exceeding the first threshold and before mixing the set of ingredients at the second speed, raising the ram for a ram sweep, and after the ram sweep, lowering the ram, the ram sweep having a duration between approximately 20 seconds and approximately 40 seconds.

In some aspects, mixing the set of ingredients at the first speed is performed simultaneously with charging the set of ingredients into the internal mixer.

Another example provides an electrically conductive rubber matting including a dissipative top layer; and a conductive base layer, the conductive base layer including 63.2 weight percent (wt %) to 73.2 wt % nitrile rubber, 25.0 wt % to 35.0 wt % polyvinyl chloride (PVC) plastic, 0.02 wt % to 1.0 wt % PVC stabilizer, and 0.8 wt % to 2.6 wt % carbon nanostructures, wherein the carbon nanostructures do not include carbon black.

In some aspects, the carbon nanostructures include carbon nanotubes.

In some aspects, the conductive base layer is a color other than black.

In some aspects, the conductive base layer is a non-marking rubber matting.

In some aspects, the conductive base layer has a volume resistivity of 10⁶ Ohms per centimeter (Ω-cm).

In some aspects, the conductive base layer includes 67.2 wt % to 69.2 wt % nitrile rubber.

In some aspects, the conductive base layer includes 29.0 wt % to 31.0 wt % wt % PVC plastic.

In some aspects, the conductive base layer includes 0.04 wt % to 0.08 wt % PVC stabilizer.

In some aspects, the conductive base layer includes 1.0 wt % to 1.4 wt % carbon nanostructures.

In some aspects, the layered construction includes a grounding cord attached to the rubber mat on one end and a connection to ground on the other end.

Other aspects of the invention will become apparent by consideration of the detailed description and accompanying drawings.

### BRIEF DESCRIPTION OF THE DRAWINGS

FIG. 1 illustrates a work environment including an electrically conductive rubber mat, according to some examples.

FIG. 2 illustrates a side view of an exemplary electrically conductive rubber mat, according to some examples.

FIG. 3 illustrates a mixer that may be used for manufacturing electrically conductive rubber mats, according to some examples.

FIG. 4 illustrates a method of manufacturing electrically conductive rubber mats, according to some examples.

### DETAILED DESCRIPTION

Before any embodiments are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

Features illustrated or described as part of one embodiment can be used with another embodiment to yield a still further embodiment. Thus, it is intended that the present disclosure covers such modifications and variations as come within the scope of the appended claims and their equivalents. The detailed description uses numerical and letter designations to refer to features in the drawings. Like or similar designations in the drawings and description have been used to refer to like or similar parts of the invention.

As used herein, the terms “first”, “second”, and “third” may be used interchangeably to distinguish one component from another and are not intended to signify location or importance of the individual components. The singular forms “a,” “an,” and “the” include plural references unless the context clearly dictates otherwise. The terms “coupled,” “fixed,” “attached to,” and the like refer to both direct coupling, fixing, or attaching, as well as indirect coupling, fixing, or attaching through one or more intermediate components or features, unless otherwise specified herein. As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present), and B is false (or not present), A is false (or not present), and B is true (or present), and both A and B are true (or present).

Terms of approximation, such as “generally,” “approximately,” or “substantially,” include values within ten percent greater or less than the stated value. When used in the context of an angle or direction, such terms include within ten degrees greater or less than the stated angle or direction. For example, “generally vertical” includes directions within ten degrees of vertical in any direction, e.g., clockwise or counterclockwise.

Benefits, other advantages, and solutions to problems are described below with regard to specific embodiments. However, the benefits, advantages, solutions to problems, and any feature(s) that may cause any benefit, advantage, or solution to occur or become more pronounced are not to be construed as a critical, required, or essential feature of any or all the claims.

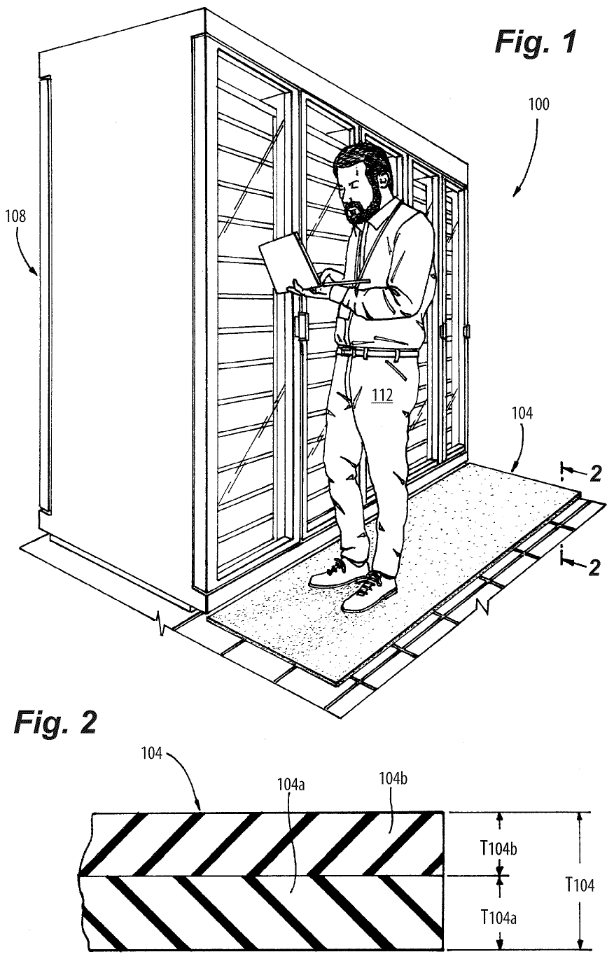

FIG. 1 illustrates an environment 100, such as a work environment 100, including electrically conductive rubber matting 104 for protecting sensitive equipment 108 from electrostatic discharge by, for example, drawing the static electricity off of a person 112 before those individuals touch the equipment. In the illustrated example, the sensitive equipment 108 includes a set of servers. However, as described above, the electrically conductive rubber matting 104 may be used in a wide variety of industries and environments including but not limited to electronics manufacturing, medical device manufacturing, laboratories, cleanrooms and critical environments, hazardous environments, and the like. The rubber matting 104 is illustrated as being placed on the floor of the work environment 100 in the example of FIG. 1. However, the use rubber matting 104 may alternatively be used in equipment transportation, and be arranged on carts, tote bags, containers, and/or the like. The rubber matting 104 may also be arranged on tables (e.g., work benches) or other surfaces in a work environment 100, or may be used in other supply chain activities where sensitive equipment 108 is involved.

In various instances, the rubber matting 104 is a multi-layered mat. FIG. 2 schematically depicts a side view of an example rubber matting 104. As shown in FIG. 2, the rubber matting 104 may include a conductive base layer 104a and a dissipative top layer 104b having a higher volume resistivity than the conductive base layer 104a. Optionally, the rubber matting 104 may include one or more additional layers (not shown) interposed between the conductive base layer 104a and the dissipative top layer 104b. Broadly, the conductive base layer 104a may include a base polymer and additives. In some instances, the conductive base layer 104a may include a base polymer (e.g., nitrile rubber, polyvinyl chloride (PVC) plastic, and/or the like) and one or more additives (e.g., conductive additives, stabilizers, etc.) mixed with the base polymer. The dissipative top layer 104b may include PVC, rubber, polyurethane, foam, sponge, and/or the like. In some instances, the rubber matting is a triple layer rubber matting 104 having a conductive layer 104a sandwiched between two dissipative layers 104b. In some embodiments, the rubber matting 104 is grounded (for example, via a grounding cord). In such embodiments, the grounding cord may be attached to the rubber matter 104 on a first end and a connection to ground on a second end.

The rubber matting 104 may have a thickness T₁₀₄ of one millimeter (“mm”) to 6 centimeters (“cm”).

The conductive base layer 104a may have a thickness T₁₀₄ₐ of 0.5 mm to 3 cm.

The dissipative top layer 104b may have a thickness T_{104b} of 0.5 cm to 3 cm.

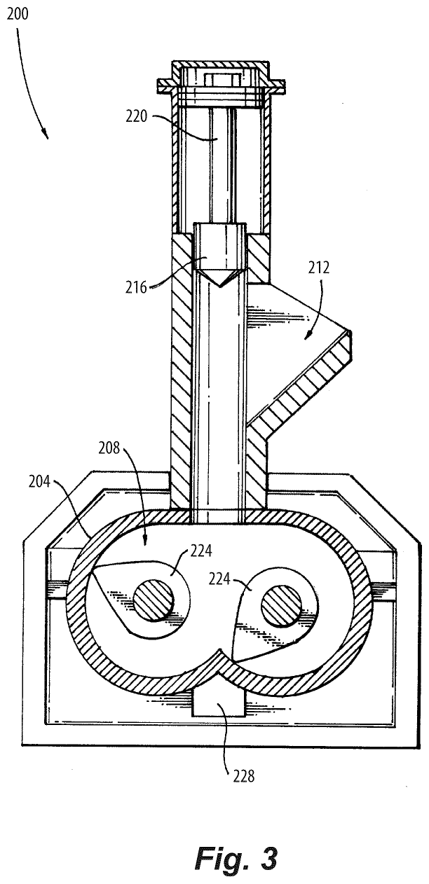

The electrically conductive rubber mat 104 may be formed from a conductive rubber compound. The conductive rubber compound may be manufactured using an internal mixer, such as the example internal mixer 200 illustrated in FIG. 3. The internal mixer 200 receives a set of batch ingredients that include one or more base polymers and other additives (e.g., conductive additives, stabilizers, etc.), described in greater detail below.

The internal mixer 200 includes a mixer body 204 and a mixing chamber 208. The batch ingredients to be mixed into a rubber compound are fed into the mixing chamber 208 through the feed hopper 212. A ram (or floating weight) 216 rests on top of the feed. The ram position and pressure may be controlled by, for example a piston-cylinder assembly 220, which is, in turn, controlled by an electronic control system of the mixer 200. The mixer 200 may be, for example, a 75-liter capacity tangential rotor mixer. However, other mixer capacities and rotor styles are contemplated.

During a mixing operation, a pair of counterrotating rotors 224 are controlled by, for example, the electronic control system of the mixer 200, to generate high shear forces that disperse fillers and other materials in the base polymer, resulting in a uniform rubber compound. The rotors 224 and/or mixer body 204 may be provided with heating or cooling chambers for controlling a temperature of the ingredients during the mixing operation. The mixer 200 may also include one or more temperature sensors (e.g., a thermocouple or the like) for measuring a temperature in the mixer 200 (e.g., a temperature of the rubber compound being mixed in the chamber 208).

The mixed rubber compound is discharged from the mixer 200 via discharge door 228. The discharge door 228 may be a slide door mechanism, a drop door, or the like. After mixing, the rubber compound is shaped (e.g., molded) into rubber matting. The rubber matting may also undergo additional processing after molding, such as trimming, coating, or the like.

FIG. 3 illustrates only one example of an internal mixer that may be used to manufacture the conductive rubber compound. Aspects of the mixer components may vary according to implementation. For example, the rotors 224 may be implemented using a variety of geometries (e.g., two-wing rotors, four-wing rotors, six-wing rotors). Additionally, the mixer 200 may include more components than are illustrated in the example of FIG. 3.

As described above, conventional electrically conductive rubber matting is made using carbon black as a conductive additive, which limits the color of the rubber matting 104 to black, and often causes black pigment to rub off on equipment or individuals (e.g., the person 112) that contact the rubber matting 104. Therefore, the conductive rubber matting 104 described herein is made using carbon nanostructures different than carbon black.

For example, the conductive rubber matting 104 described herein may be made using carbon nanostructures that include carbon nanotubes. Carbon nanotubes are nanoscale hollow tubes composed of carbon atoms. Using carbon nanotubes instead of carbon black in the rubber compound may enable the production of non-marking conductive rubber matting, wherein the conductive rubber matting may be a color other than black. However, high purity carbon nanostructures, such as carbon nanotubes, are often very costly. As a result, manufacturers of conductive rubber matting may wish to minimize or otherwise limit the use of expensive carbon nanostructures.

Maximizing the conductivity of the rubber compound while limiting the use of carbon nanostructures requires an even dispersal of the carbon nanostructures throughout the base polymer such that the carbon nanostructures form a continuous network for conducting electric current. This even dispersal of the carbon nanostructures requires high friction and, as a result, high temperatures to achieve the desired conductivity.

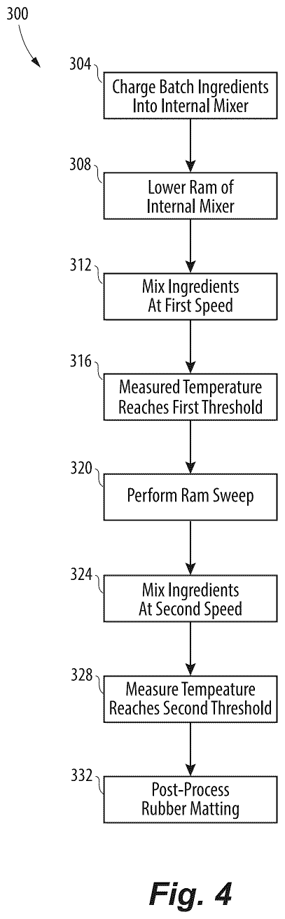

Towards this end, FIG. 4 illustrates an example method 300 for manufacturing electrically conductive rubber matting. The method 300 includes charging, into the internal mixer 200 (e.g., by way of the feed hopper 212), a set of ingredients for forming an electrically conductive rubber compound (at block 304). As described above, the set of ingredients may include a base polymer and other additives. The base polymer may include nitrile rubber and polyvinyl chloride (PVC) plastic. In some instances, the base polymer includes higher polarity polymers such as epoxidized natural rubber and epoxidized styrene-butadiene rubber (“SBR”). In some aspects, the set of ingredients includes 100% natural rubber. The additives include may include a PVC stabilizer (e.g., metal salts including zinc, cadmium, barium, and/or the like) and carbon nanostructures other than carbon black, such as carbon nanotubes. When present, the carbon nanotubes may comprise commercially available carbon nanotubes, such as TUBALL™ carbon nanotubes (available from OCSiAl) or ATHLOS™ carbon nanotubes (available from Cabot Corporation). In some instances, the carbon nanotubes comprise ATHLOS™ carbon nanotubes. In some instances, the set of ingredients includes a mixture of nitrile rubber, PVC plastic, PVC stabilizer, and carbon nanostructures, wherein each ingredient is present at varying amounts.

In some instances, the set of ingredients may include nitrile rubber at 63.2 weight percent (wt %) to 73.2 wt %. In some instances, the set of ingredients may include nitrile rubber at 64.2 wt % to 72.2 wt %; 65.2 wt % to 71.2 wt %; 66.2 wt % to 70.2 wt %; 67.2 wt % to 69.2 wt %; 67.7 wt % to 68.7 wt %; or 68.15 wt % to 69.15 wt % (e.g., 68.2 wt %). In some instances, the set of ingredients may include nitrile rubber at no greater than 73.2 wt %; no greater than 72.2 wt %; no greater than 71.2 wt %; no greater than 70.2 wt %; no greater than 69.15 wt %; or no greater than 68.2 wt %. In some instances, the set of ingredients may include nitrile rubber at no less than 64.2 wt %; no less than 64.2 wt %; no less than 65.2 wt %; no less than 66.2 wt %; no less than 67.2 wt %; no less than 68.15 wt %; or no less than 68.2 wt %.

In some instances, the set of ingredients may include PVC plastic at 25.0 wt % to 35.0 wt %. In some instances, the set of ingredients may include PVC plastic at 26.0 wt % to 34.0 wt %; 27.0 wt % to 33.0 wt %; 28.0 wt % to 32.0 wt %; 29.0 wt % to 31.0 wt %; 29.5 wt % to 30.5 wt %; or 29.95 wt % to 30.05 wt % (e.g., 30.0 wt %). In some instances, the set of ingredients may include PVC plastic at no greater than 35.0 wt %; no greater than 34.0 wt %; no greater than 33.0 wt %; no greater than 32.0 wt %; no greater than 31.0 wt %; no greater than 30.5 wt %; no greater than 30.05 wt %; or no greater than 30.0 wt %. In some instances, the set of ingredients may include PVC plastic at no less than 25.0 wt %; no less than 26.0 wt %; no less than 27.0 wt %; no less than 28.0 wt %; no less than 29.0 wt %; no less than 2.5 wt %; no less than 29.95 wt %; or no less than 30.0 wt %.

In some instances, the set of ingredients may include PVC stabilizer at 0.02 wt % to 1.0 wt %. In some instances, the set of ingredients may include PVC stabilizer at 0.03 wt % to 0.1 wt %; 0.04 wt % to 0.08 wt %; or 0.05 wt % to 0.07 wt % (e.g., 0.06 wt %). In some instances, the set of ingredients may include PVC stabilizer at no greater than 1.0 wt %; no greater than 0.1 wt %; no greater than 0.08 wt %; no greater than 0.07 wt %; or no greater than 0.06 wt %. In some instances, the set of ingredients may include PVC stabilizer at no less than 0.02 wt %; no less than 0.03 wt %; no less than 0.04 wt %; no less than 0.05 wt %; or no less than 0.06 wt %.

In some instances, the set of ingredients may include carbon nanostructures at 0.80 wt % to 2.60 wt %. In some instances, the set of ingredients may include carbon nanostructures at 0.90 wt % to 2.50 wt %; 1.00 wt % to 2.40 wt %; 1.10 wt % to 2.30 wt %; 1.15 wt % to 2.25 wt %; 1.20 wt % to 2.20 wt %; 1.25 wt % to 2.15 wt %; 1.30 wt % to 2.10 wt %; 1.35 wt % to 2.05 wt %; 1.40 wt % to 2.00 wt %; 1.45 wt % to 1.95 wt %; 1.50 wt % to 1.90 wt %; 1.55 wt % to 1.85 wt %; 1.60 wt % to 1.80 wt %; or 1.65 wt % to 1.85 wt % (e.g., 1.75 wt %). In some instances, the set of ingredients may include carbon nanostructures at no greater than 2.60 wt %; no greater than 2.50 wt %; no greater than 2.40 wt %; no greater than 2.30 wt %; no greater than 2.25 wt %; no greater than 2.20 wt %; no greater than 2.10 wt %; no greater than 2.00 wt %; no greater than 1.90 wt %; no greater than 1.80 wt %; no greater than 1.75 wt %; no greater than 1.70 wt %; no greater than 1.60 wt %; no greater than 1.50 wt %; no greater than 1.40 wt %; no greater than 1.30 wt %; no greater than 1.25 wt %; no greater than 1.20 wt %; no greater than 1.10 wt %; no greater than 1.00 wt %; or no greater than 0.90 wt %. In some instances, the set of ingredients may include carbon nanostructures at no less than 0.80 wt %; no less than 0.90 wt %; no less than 1.00 wt %; no less than 1.10 wt %; no less than 1.20 wt %; no less than 1.25 wt %; no less than 1.30 wt %; no less than 1.40 wt %; no less than 1.50 wt %; no less than 1.60 wt %; no less than 1.70 wt %; no less than 1.75 wt %; no less than 1.80 wt %; no less than 1.90 wt %; no less than 2.00 wt %; no less than 2.10 wt %; no less than 2.20 wt %; no less than 2.25 wt %; no less than 2.30 wt %; no less than 2.40 wt %; or no less than 2.50 wt %.

After the ingredients are fed into the internal mixer 200, the ram 216 is lowered (e.g., using the piston-cylinder assembly 220), thereby exerting pressure on the ingredients (at block 308). Using the rotors 224, the set of ingredients are mixed at a first speed (at block 312). The first speed may be between 30 rotations per minute (RPM) and 40 RPM (e.g., 35 RPM). However, mixing speeds and mixing times may be adapted to suit other types of internal mixers. For example, as a mixer increases in size, the ratio of mixing metal (e.g., the rotors 224) to mixed component decreases, causing a reduction in shear in the mixing process. As a result, more intense (e.g., faster and/or longer) mixing may be required in larger mixers (e.g., mixers larger than 75 liters), and less intense (e.g., slower and/or shorter) mixing may be required in smaller mixers (e.g., mixers less than 75 liters). Rotation speeds may also be dependent on rotor design. During mixing, the temperature of the rubber compound in the chamber 208 increases. Mixing may continue at the first speed at least until a measured temperature in the mixer 200 reaches a first threshold (at block 316). The first threshold temperature may be between 200 degrees Fahrenheit and 250 degrees Fahrenheit (e.g., 225 degrees Fahrenheit).

In response to the measured temperature in the mixer 200 reaching a first threshold (at block 316), the mixer 200 may perform a ram sweep, during which the ram 216 is raised and lowered (at block 320). During the ram sweep, the ram 216 is raised for a predetermined duration to allow unconsolidated material to be swept down into the chamber 208, then again lowered. The predetermined duration of the ram sweep may be between 20 seconds and 40 seconds (e.g., 30 seconds).

Additionally in response to the measured temperature reaching the first threshold, the mixing speed of the rotors 224 is increased to a second speed (at block 324). The speed of the rotors 224 may be increased to the second speed before or after the ram sweep performed at block 320. The second speed may be, for example, between 40 RPM and 50 RPM (e.g., 45 RPM). Mixing may continue at the second speed at least until the measured temperature in the mixer 200 reaches a second threshold (at block 328). The second threshold temperature may be between 285 degrees Fahrenheit and 335 degrees Fahrenheit (e.g., 310 degrees Fahrenheit).

In response to the measured temperature in the mixer 200 reaching the second threshold, formation of the conductive rubber compound batch is complete, and the batch undergoes post-processing (at block 332). For example, the rubber compound batch created according to the method 300 may be a master batch that is included at different levels in respective finished rubber matting products. Post-processing may include, for example, discharging the conductive rubber compound from the mixer 200 (e.g., via the discharge door 228), adding pigment to the rubber compound, shaping the rubber compound into the electrically conductive rubber matting (e.g., the matting 104 illustrated in FIG. 1), and curing the shaped conductive rubber matting (at block 332). The resulting rubber matting 104, formed using the method 300 of FIG. 4, may have a volume resistivity of no less than about 1 Ohms per centimeter (Ω-cm). In some instances, the resulting rubber matting 104 may have a volume resistivity of no less than 10 Ω-cm or no less than 100 Ω-cm. In some instances, the resulting rubber matting 104 may have a volume resistivity of about 10² Ω-cm to 10⁶ Ω-cm. For example, the resulting rubber matting 104 may have a volume resistivity of about 10^{2.5} Ω-cm to 10^{5.5} Ω-cm; about 10³ Ω-cm to 10⁵ Ω-cm; or about 10^{3.5} Ω-cm to 10^{4.5} Ω-cm. Conductivity of the rubber matting may be increased by the addition of more carbon nanostructures to the set of ingredients (e.g., the set of ingredients described above with respect to block 304). A final color of the rubber matting may be impacted by the amount of carbon nanotubes added. For example, more carbon nanostructures included in the batch ingredients may result in a higher conductivity but a duller color of the pigmented rubber matting.

In the foregoing specification, specific examples have been described. However, one of ordinary skill in the art appreciates that various modifications and changes can be made without departing from the scope of the claimed subject matter. Accordingly, the specification and figures are to be regarded in an illustrative rather than a restrictive sense, and all such modifications are intended to be included within the scope of present teachings.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various examples for the purpose of streamlining the disclosure. This method of disclosure is not to be interpreted as reflecting an intention that the claimed examples require more features than are expressly recited in each claim. Rather, as the following claims reflect, inventive subject matter lies in less than all features of a single disclosed example. Thus, the following claims are hereby incorporated into the Detailed Description, with each claim standing on its own as a separately claimed subject matter.

1. A method for manufacturing electrically conductive rubber matting, the method comprising:
charging, into an internal mixer, a set of ingredients for forming a rubber compound, the set of ingredients comprising
63.2 weight percent (wt %) to 73.2 wt % nitrile rubber,
25.0 wt % to 35.0 wt % polyvinyl chloride (PVC) plastic,
0.02 wt % to 1.0 wt % PVC stabilizer, and
0.8 wt % to 2.6 wt % carbon nanostructures;
lowering a ram of the internal mixer;
mixing, with the internal mixer, the set of ingredients at a first speed;
in response to a measured temperature in the internal mixer reaching a first threshold temperature, mixing the set of ingredients at a second speed that is greater than the first speed;
in response to the measured temperature in the internal mixer reaching a second threshold temperature that is greater than the first threshold temperature, discharging the rubber compound from the internal mixer; and
shaping the rubber compound,
wherein the carbon nanostructures do not include carbon black.

2. The method of claim 1, wherein the carbon nanostructures include carbon nanotubes.

3. The method of claim 1, wherein the rubber compound is a color other than black.

4. The method of claim 1, wherein the rubber compound is a non-marking rubber matting.

5. The method of claim 1, wherein the rubber compound has a volume resistivity of 10⁶ Ohms per centimeter (Ω-cm).

6. The method of claim 1, wherein the set of ingredients includes 67.2 wt % to 69.2 wt % nitrile rubber.

7. The method of claim 1, wherein the set of ingredients includes 29.0 wt % to 31.0 wt % PVC plastic.

8. The method of claim 1, wherein the set of ingredients includes 0.04 to 0.08 wt % PVC stabilizer.

9. The method of claim 1, wherein the set of ingredients includes 1.20 wt % to 2.20 wt % carbon nanostructures.

10. The method of claim 1, wherein the first speed is between 30 rotations per minute (RPM) and 40 RPM.

11. The method of claim 10, wherein the first speed is 35 RPM.

12. The method of claim 1, wherein the second speed is between 40 RPM and 50 RPM.

13. The method of claim 12, wherein the second speed is 45 RPM.

14. The method of claim 1, wherein the first threshold temperature is between 200 degrees Fahrenheit and 250 degrees Fahrenheit.

15. The method of claim 1, wherein the first threshold temperature is 225 degrees Fahrenheit.

16. The method of claim 1, wherein the second threshold temperature is between 285 degrees Fahrenheit and 335 degrees Fahrenheit.

17. The method of claim 16, wherein the second threshold temperature is 310 degrees Fahrenheit.

18. The method of claim 1, further comprising:
responsive to the measured temperature in the internal mixer exceeding the first threshold and before mixing the set of ingredients at the second speed,
raising the ram for a ram sweep, and
after the ram sweep, lowering the ram,
wherein the ram sweep has a duration between approximately 20 seconds and approximately 40 seconds.

19. The method of claim 1, wherein mixing the set of ingredients at the first speed is performed simultaneously with charging the set of ingredients into the internal mixer.

20. An electrically conductive rubber matting comprising:
a dissipative top layer; and
a conductive base layer, the conductive base layer comprising:
63.2 weight percent (wt %) to 73.2 wt % nitrile rubber,
25.0 wt % to 35.0 wt % polyvinyl chloride (PVC) plastic,
0.02 wt % to 1.0 wt % PVC stabilizer, and
0.8 wt % to 2.6 wt % carbon nanostructures,
wherein the carbon nanostructures do not include carbon black.

21. The electrically conductive rubber matting of claim 20, wherein the carbon nanostructures include carbon nanotubes.

22. The electrically conductive rubber matting of claim 20, wherein the conductive base layer is a color other than black.

23. The electrically conductive rubber matting of claim 20, wherein the conductive base layer is a non-marking rubber matting.

24. The electrically conductive rubber matting of claim 20, wherein the conductive base layer has a volume resistivity of 10⁶ Ohms per centimeter (Ω-cm).

25. The electrically conductive rubber matting of claim 20, wherein the conductive base layer includes 67.2 wt % to 69.2 wt % nitrile rubber.

26. The electrically conductive rubber matting of claim 20, wherein the conductive base layer includes 29.0 wt % to 31.0 wt % wt % PVC plastic.

27. The electrically conductive rubber matting of claim 20, wherein the conductive base layer includes 0.04 wt % to 0.08 wt % PVC stabilizer.

28. The electrically conductive rubber matting of claim 20, wherein the conductive base layer includes 1.0 wt % to 1.4 wt % carbon nanostructures.
